(19) United States
(12) Patent Application Publication
(10) Pub. No.: US 2001/0035856 A1
(43) Pub. Date: Nov. 1, 2001

(54) Palm-held computer pointing devices

(76) Inventor: Christopher S. Myers, Peoria, IL (US)

Correspondence Address: Richard J. Musgrave, Esq, Husch & Eppenberger, Suite 1400, 401 Main Street, Peoria, IL, 61602, US

(21) Appl. No.: 09/850,437

(22) Filed: May 7, 2001

Related U.S. Application Data
(60) Provisional application No. 60/202,473, filed on May 8, 2000.

(51) Int. Cl. G09G 5/00

(52) U.S. Cl. 345/156

(57) ABSTRACT

A hand-held computer pointing device has a palm-sized, low profile device housing, which is contoured to fit naturally into the palm of a user's hand and not interfere with the user's ability to type with both hands; a strap that may be used to secure the hand-held computer pointing device to the user's hand; a tracking mechanism positioned in the device housing such that it is located under the natural position of the user's thumb; a plurality of button mechanisms positioned below the user's fingers; a scrolling mechanism is generally positioned underneath the user's index finger; and is compatible with standard pointing device software.

### CROSS REFERENCES

This application claims the priority of co-pending provisional application Ser. No. 60/202,473, filed May 8, 2000.

### TECHNICAL FIELD OF THE INVENTION

This invention relates generally to computer pointing devices and, more particularly, to a mouse capable of being operated while strapped to a user's palm and used while typing; and capable of being operated without being strapped to a user's palm.

### DESCRIPTION OF THE RELATED ART

Pointing devices are a standard method of entering information into computers. The most common form of pointing device is a mouse. A standard mouse includes a trackball or similar pointing mechanism such as optical and tracking pointers as those found on laptops, which controls the movement of a cursor on a computer display, and a plurality of buttons. Two problems are inherent in the design of the standard mouse. First, a mouse is normally manipulated over a flat surface in order to induce movement in the trackball. This requires that a user have a significant amount of flat, clear surface area over which to manipulate the mouse. Second, in common computer usage involving both manipulation of the computer cursor and two-handed typing, an operator must continually shift one hand from the computer keyboard to the mouse. Further, a user surfing or searching the world wide web may only need to utilize the mouse, and not the keyboard, to the access the different screen displays. As such, a user is required to have one hand in close proximity to the mouse for manipulating same.

There are devices in the prior art directed to hand-held pointing devices. Such devices eliminate the need for a clear flat surface by providing a hand-held mouse in which the trackball is directly manipulated by a finger or thumb of the user. Two examples are disclosed in U.S. Pat. Nos. 5,760,766 and 5,668,574. The device described in U.S. Pat. No. 5,760,766 is a basically box-shaped device with a trackball, a “left” mouse button, a “right” mouse button, a “drag” button, and small indicator light. The “left” and “right” mouse buttons correspond to those on a standard two-button mouse. This design does not provide a great deal of comfort in its use. U.S. Pat. No. 5,668,574 discloses a more ergonomically designed device. Areas are provided for natural placement of the user's hand, and the trackball and buttons are more conveniently placed. However, neither of these devices address the second problem identified above. A computer operator must still abandon use of the pointing device in order to type. In fact, these devices somewhat exacerbate the problem, because the user must actually put down or pick up the pointing device before he/she can shift between cursor manipulation and typing.

The present invention is directed to overcoming one or more of the problems set forth above.

### SUMMARY OF THE INVENTION

An aspect of the present invention is to provide a hand-held computer pointing device that allows a user to control a computer cursor without the requirement of manipulating the hand-held computer pointing device across a flat surface.

Another aspect of the invention is to provide a hand-held computer pointing device that allows a user to type with both hands while maintaining control of the device.

In accordance with the above aspects of the invention, there is provided a hand-held computer pointing device with a palm-sized, low profile device housing that is contoured to fit naturally into the palm of a user's hand. The low profile device housing is, although it is not required, secured to the user's hand by a strap. The strap, small size, and low-profile nature of the device allows the user to “wear” the device at all times during computer operation without any interference in the user's ability to type with both hands. A tracking mechanism is positioned in the low profile device housing such that it is located under the natural position of the user's thumb. A plurality of button mechanisms are positioned to fall directly under the user's fingers. A scrolling mechanism is positioned underneath the user's index finger; however, the location of the scrolling mechanism could be located at other advantageous locations. The tracking mechanism, buttons, and scrolling mechanism in the device are compatible with standard pointing device software.

These aspects are merely illustrative aspects of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made to the drawings, which illustrate the best known mode of carrying out the invention and wherein the same reference numerals indicate the same or similar parts throughout the several views.

FIG. 1 is a perspective view of a strap for a hand-held computer pointing device.

FIG. 2 is perspective view of a hand-held computer pointing device, including a strap, secured to the user's palm, according to the present invention.

FIG. 3 is a view of the hand-held computer pointing device, including the strap, secured to a user's palm but with the user's hand closed.

FIG. 4 is a rear view of the hand-held computer pointing device.

FIG. 5 is a perspective view of the hand-held computer pointing device.

### DETAILED DESCRIPTION OF THE INVENTION

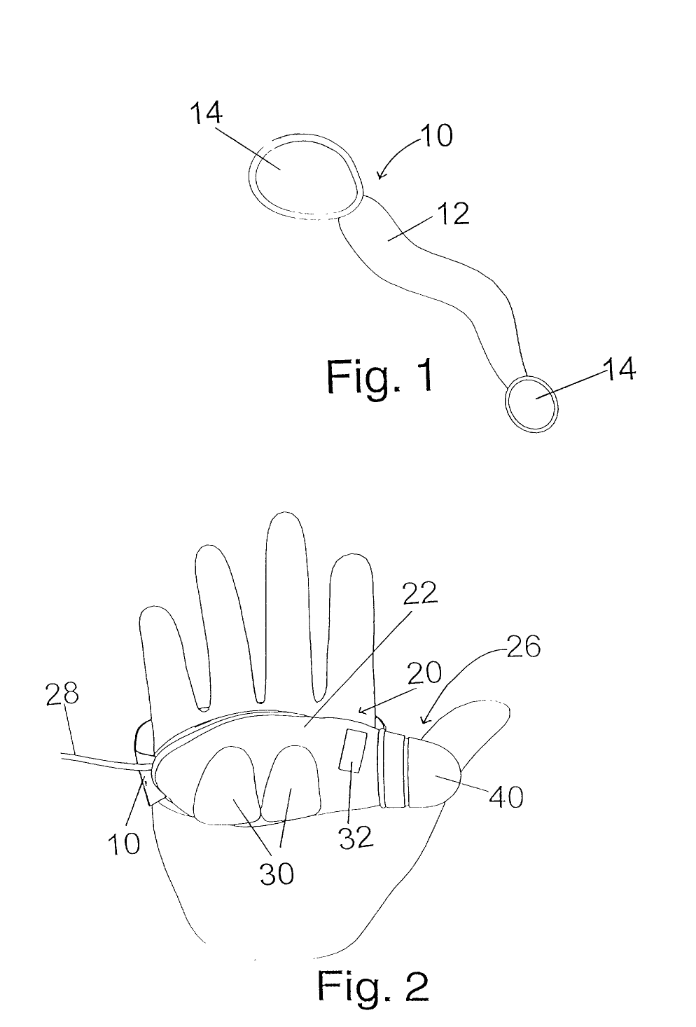

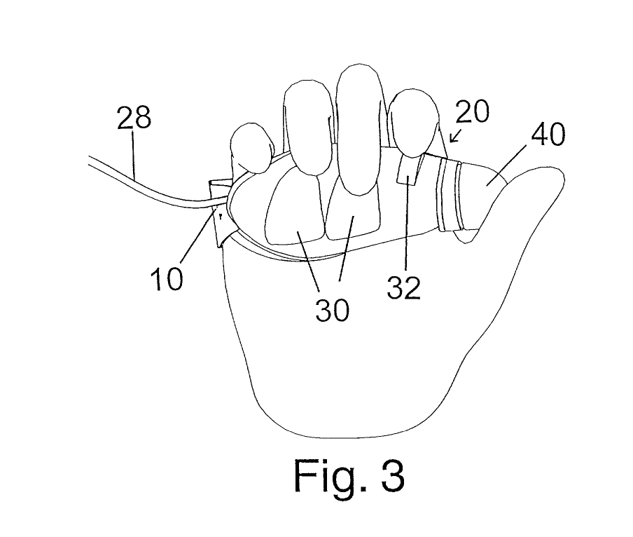

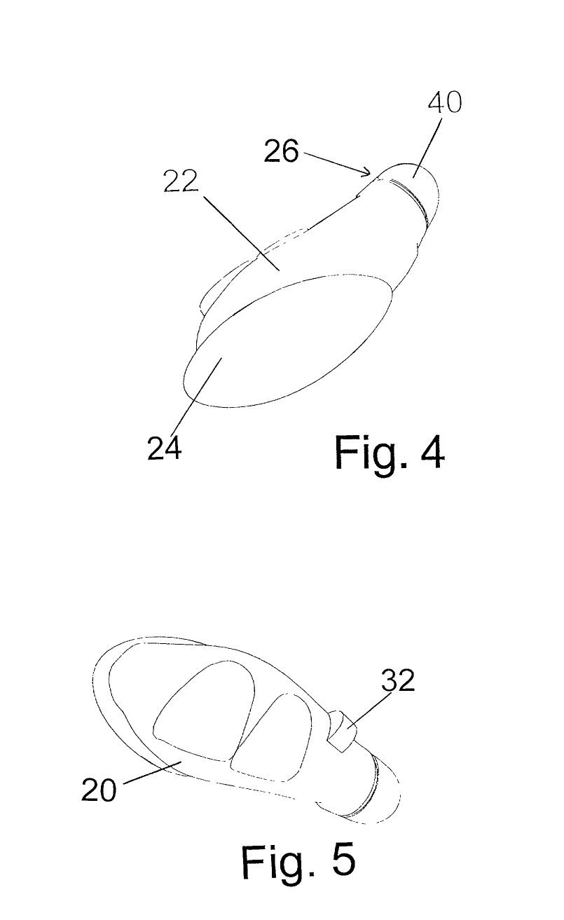

A hand-held computer pointing device 20 according to the present invention is illustrated in FIGS. 1-5. FIG. 3 illustrates how the hand-held computer pointing device 20 has a low profile device housing 22 shaped to fit within a user's palm and sized so that the user may close his/her hand around the handheld computer pointing device 20. The low profile device housing 22 has a shape slightly concave as illustrated in FIG. 4. Referring now to FIGS. 2 and 4, the low profile device housing 22 has a main bulbous portion 24 having a shape intended to fit generally within the cup of the user's palm. A neck portion 26, having a tracking mechanism 40 described hereinafter, extends from the low profile device housing 22 towards an area between the user's thumb and index finger. The tracking mechanism 40 is oriented in a position adjacent to the user's thumb. The tracking mechanism 40 is in the form of a trackball, a track button, a track pad, or other devices known in the art. The tracking mechanism 40 is positioned in the low profile device housing 22 such that it is located under the natural position of the user's thumb. FIG. 3 illustrates a plurality of button mechanisms 30 are positioned in the low profile device housing 22 within reach of the user's fingers when the user's hand is closed around the hand-held computer pointing device 20. The plurality of button mechanisms 30 are standard mouse buttons, touch-sensitive pads, or other button-equivalent devices known to those skilled in the art. The plurality of button mechanisms 30 are used to select or designate. A scrolling mechanism 32 is positioned generally underneath the user's index finger. In alternative embodiments, any available finger may be substituted for the index finger. The scrolling mechanism 32 is a scrolling mechanism; however, in alternative embodiments, a joy stick or other similar device can be used. The electronics of both the plurality of button mechanisms 30 and the scrolling mechanism 32 are also known in the art. The scrolling mechanism 32 is used to scroll pages or window contents.

The hand-held computer pointing device 20 is used in connection with the operation of a computer (not shown) or other graphical interface (not shown), such as, but not limited to interactive television and, therefore, requires some means to electronically communicate with the computer. In one embodiment, the pointing device 20 will communicate with the computer by means of a standard mouse cable 28, which is known in the art. In another embodiment, the hand-held computer pointing device 20 will contain a wireless transmitter (not shown) which communicates with a corresponding wireless receiver in the computer. Wireless communication systems of this nature are known in the art.

Referring now to FIG. 1, the hand-held computer pointing device 20 is secured to the user's hand by a strap 10. The strap 10 has a band portion 12 and at least one securing loop 14. In an alternative embodiment, the at least one securing loop 14 is substituted for other attaching means known to those skilled in the art.

In order to secure the hand-held computer pointing device 20 to a user's hand, the at least one securing loop 14 is placed around each end of the hand-held computer pointing device 20. The hand-held computer pointing device 20 and the strap 10 are slid onto the user's hand or looped on one end and stretched around the user's hand then looped around the other end, and oriented so that the hand-held computer pointing device 20 is located within the user's palm, as shown in FIGS. 2 and 3. The low profile device housing 22 is, although it is not required, secured to the user's hand by a strap 10. The strap 10, small size, and low-profile nature of the hand-held computer pointing device 20 allows the user to “wear” it at all times during computer operation with minimal interference in the user's ability to type with both hands.

The tracking mechanism 40, the mouse buttons 30, and the scrolling mechanism 32 are generally positioned to be within easy reach of the user's thumb and fingers, respectively, when the user's hand is closed around the handheld computer pointing device 20, as illustrated in FIG. 3. When the user's hand is opened, as illustrated in FIG. 2, the hand-held computer pointing device 20 is generally confined to the center of the user's palm, leaving the user's fingers and thumb unencumbered. This allows the user to use his/her fingers and thumb freely to type with minimal interference from the hand-held computer pointing device 20.

Other objects, features and advantages of the present invention will be apparent to those skilled in the art. While a preferred embodiment of the present invention has been illustrated and described, this has been by way of illustration and the invention should not be limited except as required by the scope of the appended claims and their equivalents.

We claim:

1. A hand-held computer pointing device, comprising:
a low profile device housing having a main bulbous portion and a neck portion;
a tracking mechanism located in the neck portion;
at least one button mechanism located in the low profile device housing; and
a connection for transmitting to a computer.

2. The hand-held computer pointing device as set forth in claim 1, wherein the bulbous portion is capable of fitting in a cup of a user's hand.

3. The hand-held computer pointing device as set forth in claim 1, wherein the neck portion extends outwardly from the low profile device housing towards an area between a user's thumb and forefinger.

4. The hand-held computer pointing device as set forth in claim 1, wherein the tracking mechanism is oriented in a position capable of manipulation by a user's thumb.

5. The hand-held computer pointing device as set forth in claim 1, wherein the button mechanism is oriented in a position capable of adjustment by a user's fingers when the low profile device housing is located in a user's palm.

6. The hand-held computer pointing device as set forth in claim 1, further including a scrolling mechanism located in the low profile device housing within reach of a user's finger.

7. The hand-held computer pointing device as set forth in claim 1, wherein the tracking mechanism is a trackball.

8. The hand-held computer pointing device as set forth in claim 1, wherein the tracking mechanism is a track button.

9. The hand-held computer pointing device as set forth in claim 1, wherein the tracking mechanism is a pressure sensitive pad or track pad.

10. The hand-held computer pointing device as set forth in claim 1, wherein the connection is a mouse cable.

11. The hand-held computer pointing device as set forth in claim 1, wherein the connection includes a wireless transmitter communicating with a corresponding wireless receiver in the computer.

12. The hand-held computer pointing device as set forth in claim 1, further including a strap having a first end removeably connected with the neck portion and a second end removeably connected with the bulbous portion.

13. A hand-held computer pointing device, comprising:
a low profile device housing having a bulbous portion and neck portion, wherein the bulbous portion is palm sized, wherein the neck portion extends from the bulbous portion;
a tracking mechanism located in the neck portion;
at least one button mechanism located in the housing;
a scrolling mechanism located in the low profile device housing; and
a connection for transmitting to a computer.

14. The hand-held computer pointing device as set forth in claim 13, wherein the tracking mechanism is a trackball.

15. The hand-held computer pointing device as set forth in claim 13, wherein the tracking mechanism is a track button.

16. The hand-held computer pointing device as set forth in claim 13, wherein the tracking mechanism is a pressure sensitive pad or track pad.

17. The hand-held computer pointing device as set forth in claim 13, wherein the connection is a mouse cable.

18. The hand-held computer pointing device as set forth in claim 13, wherein the connection includes a wireless transmitter capable of communicating with a corresponding wireless receiver in the computer.

19. The hand-held computer pointing device as set forth in claim 13, further including a strap having a first end removeably connected with the neck portion and a second end removeably connected with the bulbous portion.

20. A method for operating a hand-held computer pointing device, comprising:
using a thumb to adjust a tracking mechanism located in a neck portion of a housing having a bulbous portion held in a palm of a user's hand; and
using fingers to operate at least one button mechanism located in the housing.
